(19) United States
(12) Patent Application Publication
(10) Pub. No.: US 2008/0273439 A1
(43) Pub. Date: Nov. 6, 2008

(54) MOBILE RECORDING MEDIUM INCLUDING REPRODUCTION SETTING INFORMATION, AND APPARATUS AND METHOD FOR REPRODUCING CONTENTS USING REPRODUCTION SETTING INFORMATION

(75) Inventors: Ju-hee SEO, Seoul (KR); Jin-seok Choi, Yongin-si (KR); Hyang-suk Park, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/112,124

(22) Filed: Apr. 30, 2008

(30) Foreign Application Priority Data
May 3, 2007 (KR) 10-2007-0043031

(51) Int. Cl. G11B 27/00

(52) U.S. Cl. 369/83

(57) ABSTRACT

An apparatus for reproducing contents includes a reading unit which reads at least one of a plurality of reproduction setting information and at least one of a plurality of contents from a mobile recording medium, a control unit which analyzes the at least one of the plurality of reproduction setting information and sets a reproduction environment to reproduce the contents recorded on the mobile recording medium based on the analyzed at least one of the plurality of reproduction setting information, and a reproduction unit which reproduces the at least one of the plurality of contents based on the set reproduction environment.

### CROSS-REFERENCE TO RELATED PATENT APPLICATIONS

This application claims priority from Korean Patent Application No. 10-2007-0043031, filed on May 3, 2007, in the Korean Intellectual Property Office, the disclosure of which is incorporated herein in its entirety by reference.

### BACKGROUND OF THE INVENTION

1. Field of the Invention

The present invention relates to a mobile recording medium including reproduction setting information, and an apparatus and method for reproducing contents, and more particularly, to a mobile recording medium including reproduction setting information which can conveniently reproduce image or audio data in a reproduction environment that a user desires, and an apparatus and method for reproducing contents using the reproduction setting information recorded on a mobile recording medium.

2. Description of the Related Art

The use of a variety of types of electronic products to reproduce contents formed of still images, motion pictures, audio data, or multimedia data is increasing. Also, with the increased use of secure digital (SD) cards, multi-media cards (MMC), and mobile disks, a user can reproduce a single amount of content in a variety of devices having different shapes and types. To reproduce contents in various media in an optimal environment, the user needs to adjust environment settings such as image settings, audio settings, and screen ratio in a contents reproduction apparatus. Thus, whenever contents are reproduced in different contents reproduction apparatuses, the user needs to appropriately adjust reproduction environment settings.

### SUMMARY OF THE INVENTION

Exemplary embodiments of the present invention address at least the above problems and/or disadvantages and other disadvantages not described above. Also, the present invention is not required to overcome the disadvantages described above, and an exemplary embodiment of the present invention may not overcome any of the problems described above.

The present invention provides a mobile recording medium including contents reproduction setting information to reproduce contents in a reproduction environment without applying reproduction environment settings.

Apparatuses and methods for reproducing contents using reproduction setting information recorded on a mobile recording medium are also provided.

According to an aspect of the present invention, there is provided a mobile recording medium including at least one of a plurality of contents; and at least one of a plurality of pieces of reproduction setting information indicating a value to set a reproduction environment of the contents in a contents reproduction apparatus processing data recorded on the mobile recording medium.

According to another aspect of the present invention, there is provided a method for reproducing contents, the method including reading at least one of a plurality of contents and at least one of a plurality of pieces of reproduction setting information from a mobile recording medium; analyzing the read reproduction setting information, setting a reproduction environment of a contents reproduction apparatus which reproduces the contents recorded on the mobile recording medium based on the reproduction setting information, and reproducing the at least one of the contents based on the set reproduction environment, wherein the reproduction setting information indicates a value to set a reproduction environment of the contents in a contents reproduction apparatus which processes data recorded on the mobile recording medium.

According to another aspect of the present invention, there is provided a contents reproduction apparatus including a reading unit which reads at least one of a plurality of pieces of reproduction setting information and at least one of a plurality of contents from a mobile recording medium, a control unit which analyzes the reproduction setting information and sets a reproduction environment to reproduce the contents recorded on the mobile recording medium based on the analyzed reproduction setting information, and a reproduction unit which reproduces the contents based on the set reproduction environment, wherein the reproduction setting information indicates a value to set a reproduction environment of the contents in the contents reproduction apparatus which processes data recorded on the mobile recording medium.

According to another aspect of the present invention, there is provided a computer readable recording medium which has recorded thereon a program to embody a contents reproduction method comprising reading at least one of a plurality of contents and at least one of a plurality of pieces of reproduction setting information from a mobile recording medium, analyzing the read reproduction setting information, setting a reproduction environment of a contents reproduction apparatus which reproduces the contents recorded on the mobile recording medium based on the reproduction setting information, and reproducing the at least one of the contents based on the set reproduction environment.

### BRIEF DESCRIPTION OF THE DRAWINGS

The above and other features and advantages of the present invention will become more apparent by describing in detail exemplary embodiments thereof with reference to the attached drawings in which:

FIGS. 1A to 1D illustrate structures of mobile recording media according to exemplary embodiments of the present invention;

FIG. 2 is a block diagram of a contents reproduction apparatus according to an exemplary embodiment of the present invention;

FIG. 3 shows the structure of a reproduction setting information file according to an exemplary embodiment of the present invention;

FIGS. 4A to 4D show setting values for the types of reproduction setting information file, according to an exemplary embodiment of the present invention;

FIG. 5 is a flowchart illustrating a contents reproduction method according to an exemplary embodiment of the present invention; and

FIG. 6 is a flowchart illustrating a contents reproduction method according to another exemplary embodiment of the present invention.

### DETAILED DESCRIPTION OF THE EXEMPLARY EMBODIMENTS

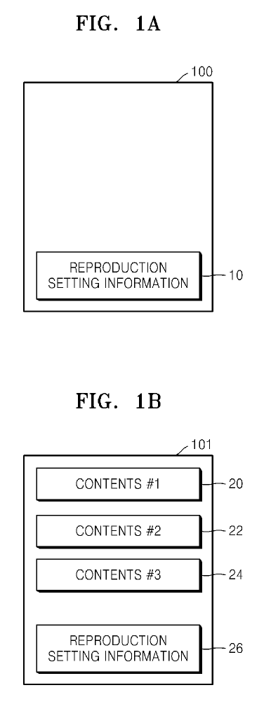

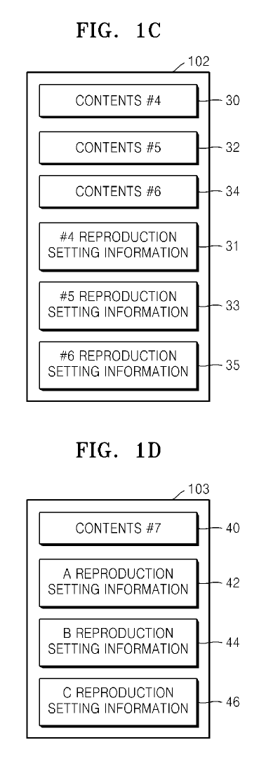

FIGS. 1A to 1D illustrate structures of a mobile recording media 100, 101, 102 and 103, respectively, according to exemplary embodiments of the present invention. The mobile recording medium includes compact flash (CF) cards, secure digital (SD) cards, multi-media cards (MMC), memory sticks (MS), and mobile disks. Referring to FIGS. 1A to 1D, the mobile recording media 100, 101, 102 and 103 include at least one piece of reproduction setting information indicating a value to set a reproduction environment of contents in a contents reproduction apparatus. The reproduction setting information is identified by an identifier indicating reproduction setting information. For example, the reproduction setting information can be identified using a file extension indicating the reproduction setting information. The file extension name of the reproduction setting information may be, for example, “.gsf (global setting file)”.

Referring to FIG. 1A, reproduction setting information 10 is stored in an effective memory space of the mobile recording medium 100. The reproduction setting information 10 can be recorded to have an initial value when the mobile recording medium 100 is manufactured, or recorded or modified by an apparatus for reproducing the contents recorded on the mobile recording medium 100 or recording the contents on the mobile recording medium 100.

The reproduction setting information includes at least one of, for example, but not limited to, languageType information, fontType information, fontSize information, subTitlePosition information, subTitleColor information, screenRatio information, screenMode information, volume information, audioChannel information, and soundMode information. The reproduction setting information can include a reproduction environment setting value distinguished according to the type of the reproduction setting information. Data forming the reproduction setting information is not limited by the information, particular form, or structure of the above listed types.

Referring to FIG. 1B, the mobile recording medium 101 includes at least one of a plurality of contents including at least one of different types of data such as audio data, still images, and video data. There is no limit to the number or type of the contents recorded on the mobile recording medium 101. Contents #1 20, contents #2 22, and contents #3 24 can be reproduced by a contents reproduction apparatus in which a reproduction environment is set by a piece of reproduction setting information 26.

Referring to FIG. 1C, the mobile recording medium 102 includes reproduction setting information for each of a plurality of contents. In more detail, the mobile recording medium 102 includes reproduction setting information 31 for contents #4 30, reproduction setting information 33 for contents #5 32, and reproduction setting information 35 for contents #6 34. When the types of the contents #4 30, contents #5 32, and contents #6 34 are different from one another, the reproduction setting information 31, 33, and 35 exist for the type of each content.

Referring to FIG. 1D, the mobile recording medium 103 includes contents #7 40 and reproduction setting information for the type of each of a plurality of devices, that is, reproduction setting information 42 about a device type A, reproduction setting information 44 about a device type B, and reproduction setting information 46 about a device type C. When reading the reproduction setting information 42, 44, and 46 from the mobile recording medium 103, the contents reproduction apparatus selects reproduction setting information according to the type of a device and sets an environment of the contents reproduction apparatus based on the selected reproduction setting information.

The contents and reproduction setting information included in the mobile recording medium according to the exemplary embodiments of the present invention can be modified to various types in addition to the structures illustrated in FIGS. 1A to 1D.

When the mobile recording medium is a secure MMC, the reproduction setting information can be recorded in a user data area or restricted area so that the contents reproduction apparatus processing data recorded on the mobile recording medium reads the reproduction setting information when authentication using a secret key included in a secure area is successfully performed. When the mobile recording medium is an SD card, when authentication using a secret key included in a hidden area is successfully performed, to read reproduction setting information, the reproduction setting information can be recorded in a user data area or a protected area.

Also, to use the reproduction setting information for the environment setting of a contents reproduction apparatus according to an individual user, the mobile recording medium may further include an authentication key to authenticate at least one user. The reproduction setting information may exist for at least one user distinguished by an authentication key for authentication.

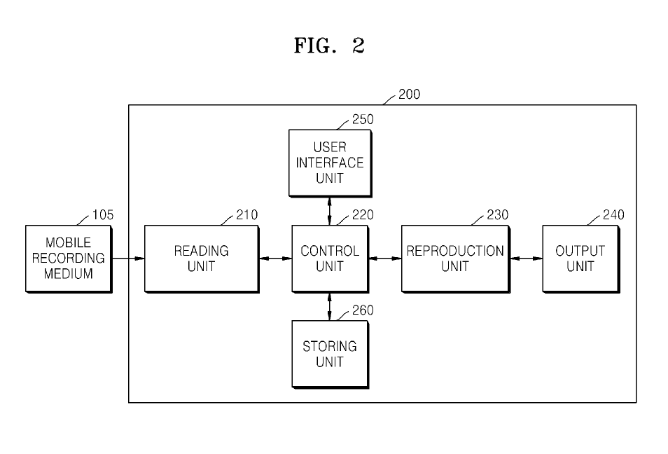

FIG. 2 is a block diagram of a contents reproduction apparatus 200 according to an exemplary embodiment of the present invention. Referring to FIG. 2, the contents reproduction apparatus 200 which reproduces contents using reproduction setting information recorded on a mobile recording medium 105 according to an exemplary embodiment of the present invention includes a reading unit 210, a control unit 220, a reproduction unit 230, an output unit 240, a user interface unit 250, and a storing unit 260. The contents reproduction apparatus 200 reads the reproduction setting information recorded on the mobile recording medium 105 and reproduces contents based on the read reproduction setting information.

The reading unit 210 reads at least one of a plurality of contents and at least one of a plurality of pieces of reproduction setting information recorded on the mobile recording medium 105. The reading unit 210 is configured to install various types of mobile recording media to read data stored in the various types of mobile recording media. The reading unit 210 included in the contents reproduction apparatus 200 may be internal or external to the contents reproduction apparatus 200.

When the mobile recording medium 105 is a secure MMC, the reading unit 210 reads the reproduction setting information from a user data area or restricted area. When the mobile recording medium 105 is an SD card, the reading unit 210 reads the reproduction setting information from a user data area or protected area.

The control unit 220 controls the reproduction unit 230 to reproduce contents based on a setting value according to a reproduction environment. Also, the control unit 220 analyzes reproduction setting information and sets the reproduction environment of the contents reproduction apparatus 200 to reproduce the contents recorded on the mobile recording medium 105 based on the analyzed reproduction setting information. That is, the setting value according to the type of each of the pieces of information included in the reproduction setting information recorded on the mobile recording medium 105 is reflected in the setting value for the reproduction environment of the contents reproduction apparatus 200.

The control unit 220 selects reproduction setting information that can be used according to the specification of the contents reproduction apparatus 200 among the analyzed reproduction setting information and uses the selected information in the setting of the reproduction environment. For example, even when a setting value for a font type is included in the reproduction setting information on the mobile recording medium 105, if the contents reproduction apparatus 200 is not able to provide a front type according to the setting value, the reproduction setting information is skipped.

The reproduction unit 230 processes and reproduces contents based on the set reproduction environment, that is, a set value read from the mobile recording medium 105. The output unit 240 outputs data that has undergone a reproduction process of contents such as decoding to the reproduction unit 230. The control unit 220 analyzes data stored on the mobile recording medium 105, forms a screen to provide information on at least one of the contents recorded on the mobile recording medium 105, and outputs the screen through the output unit 240. That is, information about at least one of the contents stored on the mobile recording medium 105 can be provided to a user.

The user interface unit 250 in the form of, for example, but not limited to, a touch pad or a key pad including a user input key button receives a user input signal. The received user input signal is transferred to the control unit 220. The control unit 220 controls internal constituent elements of the contents reproduction apparatus 200 according to the user input signal.

When information about at least one of a plurality of contents is provided, the user inputs a user input signal to select one of the at least one of the contents through the user interface unit 250. When the user input signal to select the contents is input, the control unit 220 selects reproduction setting information about the contents selected according to the user input signal among the reproduction setting information recorded on the mobile recording medium 105 to be used for the reproduction environment setting of the contents reproduction apparatus 200.

When the user input signal to input the reproduction setting information is input through the user interface unit 250, the control unit 220 records the reproduction setting information recorded on the mobile recording medium 105 based on the user input signal that is input, or corrects the recorded reproduction setting information.

Also, when information about user authentication is input from the user interface unit 250, for example, an ID or password is input or information on a fingerprint is input, the control unit 20 performs an authentication process to check whether the reading of data using an authentication key recorded on the mobile recording medium 105 is allowed. According to the present exemplary embodiment, the reading unit 210 is configured to read the reproduction setting information from the mobile recording medium 105 when the authentication process is normally performed under the control of the control unit 220.

When the reproduction setting information recorded on the mobile recording medium 105 is distinguished one from another according to the type of the contents, the control unit 220 selects reproduction setting information corresponding to the contents type selected according to the user input signal and uses the selected reproduction setting information for the reproduction environment setting of the contents reproduction apparatus 200. Also, when, the reproduction setting information is recorded on the mobile recording medium 105 distinguished one from another according to the type of the contents reproduction apparatues 200, the contents reproduction apparatus 200 selects reproduction setting information appropriate to the type of the contents reproduction apparatus 200 and uses the selected reproduction setting information for the reproduction environment setting of the contents reproduction apparatus 200.

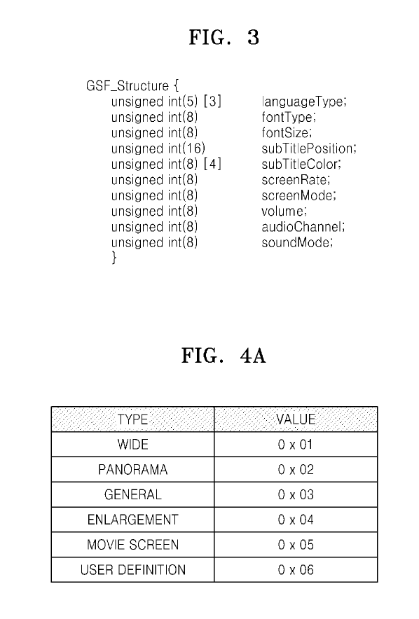

FIG. 3 shows the structure of a reproduction setting information file according to an exemplary embodiment of the present invention. Referring to FIG. 3, the reproduction setting information includes languageType information, fontType information, fontSize information, subTitlePosition information, subTitleColor information, screenRatio information, screenMode information, volume information, audioChannel information, and soundMode information. The reproduction setting information includes the above information and can be stored on a mobile recording medium as a file formed of fields distinguished according to the type of information.

The languageType information can be defined according to ISO 639-2/T indicating an agreed language in three character codes. The fontType information is defined in the form of letters. The fontSize information defines the size of pixels in numbers. The subTitlePosition information defines the position of subtitles on a screen and can be expressed, for example, using information on an x-coordinate and a y-coordinate for each byte. The subTitleColor information indicates the color of subtitles.

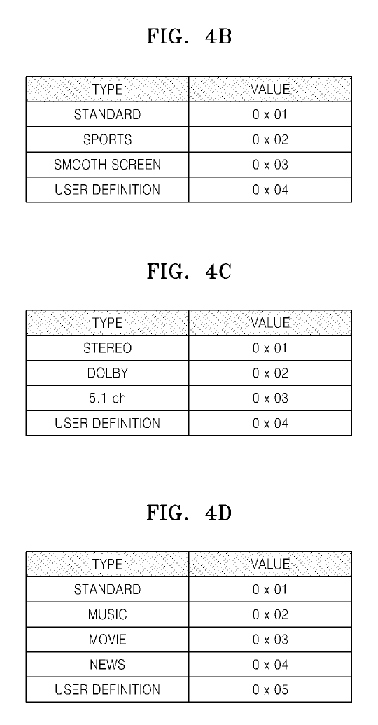

FIGS. 4A to 4D show setting values for the types of the reproduction setting information file, according to an exemplary embodiment of the present invention. FIG. 4A shows a setting value for each type of the screenRatio information. FIG. 4B shows a setting value for each type of the screenMode information. FIG. 4C shows a setting value for each type of the audioChannel information. FIG. 4D shows a setting value for each type of the soundMode information. The setting values for each type of the reproduction setting information are stored in a storing space of the contents reproduction apparatus 200. The setting values for each type of the reproduction setting information may be stored in a variety of forms. The reproduction setting information is stored to be referred by the control unit 220 of the contents reproduction apparatus 200 and in the form of a file included in a reproduction application to reproduce the contents that is performed by the reproduction unit 230 of the contents reproduction apparatus 200.

Thus, the contents reproduction apparatus 200 referring to the setting value for each type of the reproduction setting information analyzes the reproduction setting information recorded on the mobile recording medium 105 and sets a reproduction environment of the contents reproduction apparatus 200 using a value of the analyzed reproduction setting information as shown in FIGS. 1A to 1D.

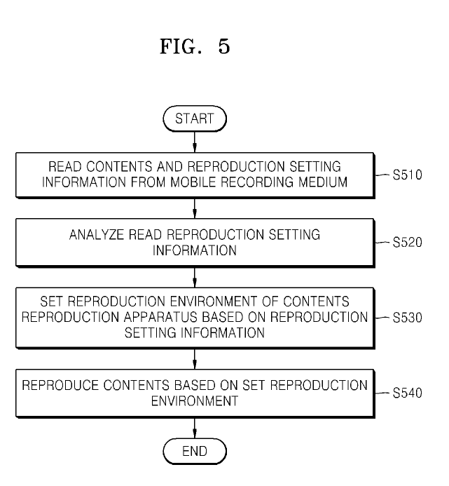

FIG. 5 is a flowchart illustrating a contents reproduction method according to an exemplary embodiment of the present invention. Referring to FIG. 5, at least one of a plurality of pieces of reproduction setting information and at least one of a plurality of contents are read from a mobile recording medium (S510). The reading of the at least one of the contents includes reading of a file including information about at least one of the contents included in the mobile recording medium.

The read reproduction setting information is then analyzed (S520), and a reproduction environment of a contents reproduction apparatus to reproduce the contents recorded on the mobile recording medium is set based on the reproduction setting information (S530).

Before S530 is performed, the contents reproduction apparatus provides information about the at least one of the contents stored on the mobile recording medium. When a user input signal to select the at least one of the contents is received, the reproduction setting information about the contents selected according to the user input signal of the reproduction setting information about the read contents can be selected as a value for the reproduction environment setting of the contents reproduction apparatus. That is, the selected reproduction setting information is used for the reproduction environment setting of the contents reproduction apparatus. The contents are then reproduced based on the set reproduction environment (S540).

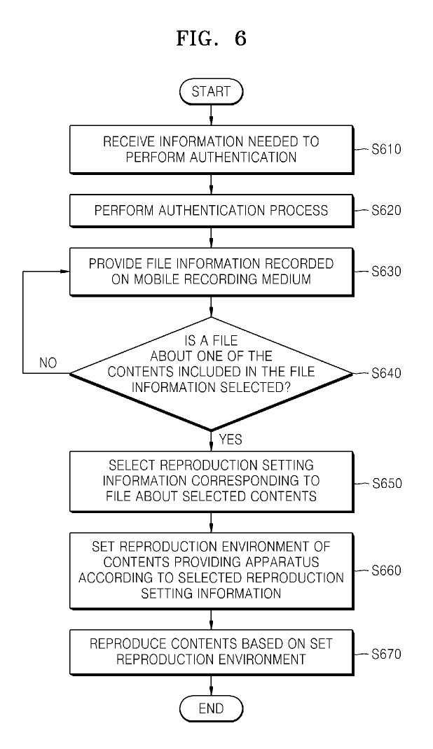

FIG. 6 is a flowchart illustrating a contents reproduction method according to another exemplary embodiment of the present invention. Referring to FIG. 6, information needed to perform authentication for use of a mobile recording medium, for example, a password and an ID or fingerprint information, is received from a user (S610). When the information needed to perform authentication is input, an authentication key is read from the mobile recording medium, an authentication process is performed using the authentication key and the information needed to perform authentication (S620). The authentication process can be performed using a variety of methods.

When the authentication process normally performed, the file information recorded on the mobile recording medium is read from the mobile recording medium and is provided to the user (S630). The file information includes brief information about a file and the structure of a file including the reproduction setting information of the mobile recording medium.

When a user input signal to select a file about one of the contents included in the file information is received (S640), the contents reproduction apparatus selects reproduction setting information corresponding to a file about the contents selected by the user input signal of the reproduction setting information read from the mobile recording medium and analyzed (S650). The reproduction environment of the contents reproduction apparatus is then set according to the selected reproduction setting information (S660). The contents are then reproduced by processing the contents file selected in S640 based on the set reproduction environment (S670).

When the reproduction setting information is recorded on the mobile recoding medium according to at least one of the type of the contents and the type of the contents reproduction apparatus, the reproduction environment of the contents reproduction apparatus can be set using the reproduction setting information selected based on the contents reproduction apparatus reproducing the contents recorded on the mobile recording medium or the contents type selected according to the user input signal of the reproduction setting information stored on the mobile recording medium.

The exemplary embodiments of the present invention can also be embodied as computer readable codes stored on a computer readable recording medium. The computer readable recording medium is any data storage device that can store data which can be thereafter read by a computer system. Examples of the computer readable recording medium include, but are not limited to, read-only memory (ROM), random-access memory (RAM), CD-ROMs, magnetic tapes, floppy disks, and optical data storage devices. The computer readable recording medium can also be distributed over network coupled computer systems so that the computer readable code is stored and executed in a distributed fashion. Also, functional programs, codes, and code segments for accomplishing the present invention can be easily construed by programmers skilled in the art to which the present invention pertains.

According to the present invention, since a user does not need to set a reproduction environment in a contents reproduction apparatus whenever reproducing contents recorded on a mobile recording medium, the contents can be reproduced in the reproduction environment that the user desires. Also, when the contents recorded on the mobile recording medium are reproduced by another contents reproduction apparatus, the contents can be reproduced in the reproduction environment that the user desires, without separately setting the reproduction environment.

While this invention has been particularly shown and described with reference to exemplary embodiments thereof, it will be understood by those skilled in the art that various changes in form and details may be made therein without departing from the spirit and scope of the invention as defined by the appended claims.

What is claimed is:

1. A mobile recording medium comprising:
at least one of a plurality of contents; and
at least one of a plurality of reproduction setting information indicating a value to set a reproduction environment of the at least one of the contents in a contents reproduction apparatus which processes data recorded on the mobile recording medium.

2. The mobile recording medium of claim 1, wherein the at least one of the plurality of reproduction setting information comprises a reproduction environment setting value distinguished according to a type of at least one of the plurality of reproduction setting information comprising at least one of languageType information, fontType information, fontSize information, subTitlePosition information, subTitleColor information, screenRatio information, screenMode information, volume information, audioChannel information, and soundMode information.

3. The mobile recording medium of claim 1, wherein the at least one of the plurality of reproduction setting information is recorded or corrected by a user using an apparatus capable of recording data on the mobile recording medium.

4. The mobile recording medium of claim 1, wherein, when the mobile recording medium is a secure multi-media card (MMC), the at least one of the plurality of reproduction setting information is recorded in a user data area or a restricted area of the MMC.

5. The mobile recording medium of claim 1, wherein, when the mobile recording medium is a secure digital (SD) card, the at least one of the plurality of reproduction setting information is recorded in a user data area or a protected area of the SD card.

6. The mobile recording medium of claim 1, further comprising an authentication key to authenticate at least one user, wherein the at least one of the plurality of reproduction setting information exists corresponding to each of at least one user distinguished by the authentication key.

7. The mobile recording medium of claim 1, wherein the at least one of the plurality of reproduction setting information exists according to at least one of a plurality of types of contents and a type of the contents reproduction apparatus.

8. A method of reproducing contents, the method comprising:
reading at least one of a plurality of contents and at least one of a plurality of reproduction setting information from a mobile recording medium;
analyzing the read at least one of the plurality of reproduction setting information;
setting a reproduction environment of a contents reproduction apparatus which reproduces the at least one of the plurality of contents recorded on the mobile recording medium based on the at least one of the plurality of reproduction setting information; and
reproducing the at least one of the plurality of contents based on the set reproduction environment,
wherein the reproduction setting information indicates a value to set the reproduction environment of the contents in a contents reproduction apparatus which processes data recorded on the mobile recording medium.

9. The method of claim 8, further comprising receiving a user input signal to select the at least one of the plurality of contents, wherein, in the setting of the reproduction environment of the contents reproduction apparatus which reproduces the contents recorded on the mobile recording medium based on the at least one of the plurality of reproduction setting information, at least one of the plurality of reproduction setting information about the at least one of the plurality of contents selected according to the user input signal is selected from the analyzed at least one of the plurality of reproduction setting information and the selected at least one of the plurality of reproduction setting information is used for reproduction environment setting of the contents reproduction apparatus.

10. The method of claim 8, wherein the at least one of the plurality of reproduction setting information comprises a reproduction environment setting value distinguished according to the type of reproduction setting information comprising at least one of languageType information, fontType information, fontSize information, subTitlePosition information, subTitleColor information, screenRatio information, screenMode information, volume information, audioChannel information, and soundMode information.

11. The method of claim 8, further comprising recording or correcting the at least one of the plurality of reproduction setting information using the contents reproduction apparatus.

12. The method of claim 8, further comprising prior to the reading of the at least one of the plurality of reproduction setting information from the mobile recording medium, performing an authentication process to check whether reading of data recorded on the mobile recording medium is allowed, wherein the at least one of the plurality of reproduction setting information is read from the mobile recording medium when the authentication process is normally performed.

13. The method of claim 8, wherein, when the at least one of the plurality of reproduction setting information is recorded on the mobile recording medium according to at least one of a plurality of types of contents and the type of the contents reproduction apparatus, in the setting of the reproduction environment of the contents reproduction apparatus, the at least one of the plurality of reproduction setting information is selected based on the at least one of the plurality of types of contents selected according to a user input signal or type of the contents reproduction apparatus which reproduces the contents recorded on the mobile recording medium from the analyzed at least one of the plurality of reproduction setting information, and the selected at least one of the plurality of reproduction setting information is used for the reproduction environment setting of the contents reproduction apparatus.

14. A contents reproduction apparatus comprising:
a reading unit which reads at least one of a plurality of reproduction setting information and at least one of a plurality of contents from a mobile recording medium;
a control unit which analyzes the at least one of the plurality of reproduction setting information and sets a reproduction environment to reproduce the at least one of the plurality of contents recorded on the mobile recording medium based on the analyzed at least one of the plurality of reproduction setting information; and
a reproduction unit which reproduces the at least one of the plurality of contents based on the set reproduction environment,
wherein the at least one of the plurality of reproduction setting information indicates a value to set the reproduction environment of the at least one of the plurality of contents in the contents reproduction apparatus which processes data recorded on the mobile recording medium.

15. The apparatus of claim 14, further comprising:
an output unit which provides information on the at least one of the plurality of contents stored on the mobile recording medium; and
a user interface unit which receives a user input signal to select one of the at least one of the plurality of contents,
wherein the control unit selects at least one of the plurality of reproduction setting information on the at least one of the plurality of contents selected according to a user input signal from the analyzed at least one of the plurality of reproduction setting information and the selected at least one of the plurality of reproduction setting information is used for the reproduction environment setting of the contents reproduction apparatus.

16. The apparatus of claim 14, wherein the at least one of the plurality of reproduction setting information comprises a reproduction environment setting value distinguished according to a type of reproduction setting information comprising at least one of languageType information, fontType information, fontSize information, subTitlePosition information, subTitleColor information, screenRatio information, screenMode information, volume information, audioChannel information, and soundMode information.

17. The apparatus of claim 14, wherein the control unit records or corrects the at least one of the plurality of reproduction setting information recorded on the mobile recording medium based on a user input signal to input the at least one of the plurality of reproduction setting information.

18. The apparatus of claim 14, wherein the control unit performs an authentication process to check whether reading of data recorded on the mobile recording medium is allowed, and the reading unit reads the at least one of the plurality of reproduction setting information from the mobile recording medium when the authentication process is normally performed.

19. The apparatus of claim 14, wherein, when the at least one of the plurality of reproduction setting information is recorded on the mobile recording medium according to at least one of a plurality of types of contents and a type of the contents reproduction apparatus, the control unit uses the at least one of the plurality of reproduction setting information selected based on the at least one of the plurality of types of contents selected according to a user input signal or the type of the contents reproduction apparatus from the analyzed at least one of the plurality of reproduction setting information.

20. A computer readable recording medium having recorded thereon a program for causing a computer to perform a contents reproduction method, the method comprising:
reading at least one of a plurality of contents and at least one of a plurality of reproduction setting information from a mobile recording medium;
analyzing the read at least one of the plurality of reproduction setting information;
setting a reproduction environment of a contents reproduction apparatus which reproduces the at least one of the plurality of contents recorded on the mobile recording medium based on the at least one of the plurality of reproduction setting information; and
reproducing the at least one of the plurality of contents based on the set reproduction environment.
